(19) United States
(12) Patent Application Publication
(10) Pub. No.: US 2010/0188184 A1
(43) Pub. Date: Jul. 29, 2010

(54) INDUCTOR AND CORE MEMBER THEREOF

(75) Inventor: GUNG FU CHEN, TAOYUAN COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHILISIN ELECTRONICS CORP., HSINCHU (TW)

(21) Appl. No.: 12/687,369

(22) Filed: Jan. 14, 2010

(30) Foreign Application Priority Data
Jan. 23, 2009 (TW) 098201426

(51) Int. Cl. H01F 17/04

(52) U.S. Cl. 336/221

(57) ABSTRACT

An inductor comprises a core member including a groove portion and a wire-winding portion. The groove portion extends through the wire-winding portion along the direction of the wire-winding axis, and the groove portion's cross-sectional area perpendicular to the wire-winding axis is in the range of from one-third to one-half of the core member's entire cross-sectional area perpendicular to the wire winding axis.

### BACKGROUND OF THE INVENTION

1. Field of the Invention

The present invention relates to an inductor and the core member thereof, and relates more particularly to a core member adapted for high frequency and low frequency applications and an inductor using the core member.

2. Description of the Related Art

An inductor has a generalized configuration, which includes a core and a conductive element wound around the core. Generally, the conductive element may be a copper wire, and the core may be made of ferromagnetic material. In addition to a ferromagnetic core, the core can be an air core such that the core and the conductive element are assembled into a coreless coil inductor. Compared with a coreless coil inductor, the inductor using a ferromagnetic core can efficiently confine the magnetic field near the core so as to increase inductance, and thus a small inductor of high inductance can be manufactured.

The technique using higher operating frequency to reduce the size of an inductor is well known, now adopted for producing inductors used for the electronic apparatuses that are demanded in continuously reduced size and weight. However, as the operating frequency increases, significant iron losses in cores are incurred, and most ferromagnetic materials suffer large iron losses as the operating frequency exceeds 100 MHz. Such losses incurred by high operating frequency limit the extent of the size reduction in inductors.

For the same inductance value, coreless coil inductors require larger coils and/or greater numbers of winding turns, increasing the volume of the coil. However, an air core does not induce iron losses when operated at high frequencies, and in addition, it has a better Q factor and higher efficiency. Further, a coreless coil can be operated at up to 1 GHz operating frequency. Thus, for high frequency, low inductance applications, coreless coils are usually the priority choice of design.

To meet the requirements of high frequency applications, the improvement of the magnetic characteristics of ferromagnetic materials is the research focus for most inductors, reducing eddy current losses at high frequency so as to increase the frequency range of applications thereof and to minimize the size thereof. However, to date the achievement of the improvement of ferromagnetic materials has been very limited. Unlike air cores, inductor cores made of ferromagnetic materials have not been developed to be free of iron losses at high frequency.

In summary, the cores of inductors suffer high core losses at high frequency, and there is as of yet no effective solution for this issue so that no inductor now can have high inductance when it is operated at low frequency, and have low core losses and high Q factor when it is operated at high frequency.

### SUMMARY OF THE INVENTION

The present invention proposes an inductor including a core member having an air-core part so that the inductor can now have high inductance when it is operated at low frequency, and can have low core losses when operated at high frequency.

One embodiment of the present invention proposes a core member having a wire-winding axis. The core member comprises a groove portion and a wire-winding portion. The groove portion extends through the wire-winding portion along a direction of the wire-winding axis, wherein on a cross section, perpendicular to the wire-winding axis, of the wire-winding portion, a cross-sectional area of the groove portion is in the range of from about one-third to one-half of the area of the cross section.

One embodiment of the present invention proposes an inductor comprising the above-mentioned core member and a coil wound around the wire-winding portion of the core member.

### BRIEF DESCRIPTION OF THE DRAWINGS

The invention will be described according to the appended drawings in which:

FIG. 1 is a perspective view showing an inductor according to one embodiment of the present invention;

FIG. 2 is a perspective view showing a core member according to one embodiment of the present invention;

FIG. 3 is a cross-sectional view along line A-A in FIG. 2;

FIG. 4 is a perspective view showing a core member according to another embodiment of the present invention; and

FIG. 5 is a perspective view showing a core member according to another embodiment of the present invention.

### DETAILED DESCRIPTION OF THE INVENTION

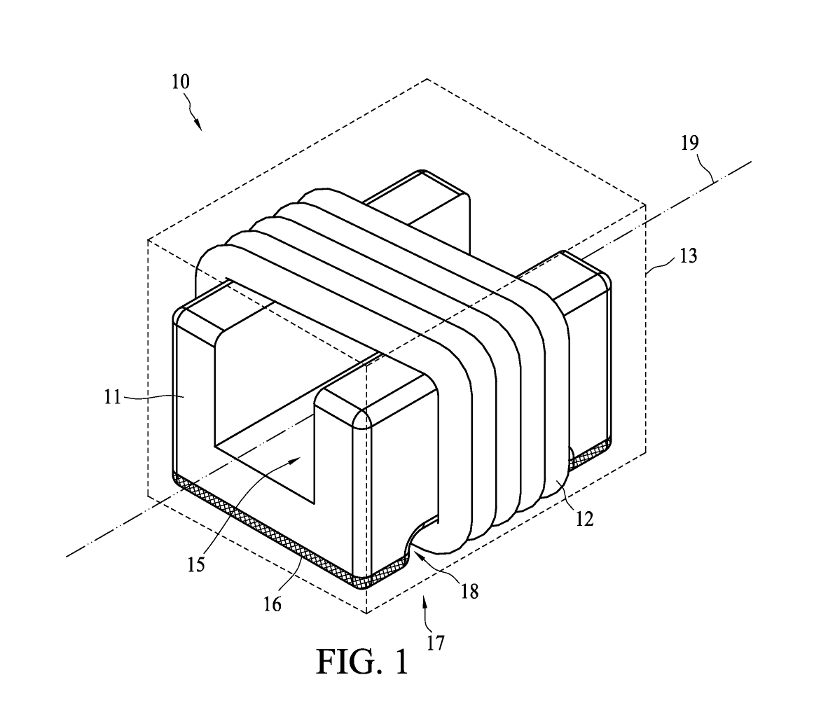

FIG. 1 is a perspective view showing an inductor 10 according to one embodiment of the present invention. The inductor 10 of the present embodiment comprises a core member 11, a coil 12 and a conductive shield 13. The coil 12 is wound around the core member 11, and the conductive shield 13 configured for shielding electromagnetic energy and confining magnetic field is disposed to cover the coil 12. The inductor 10 is adapted to be mounted utilizing surface mount technology so that a recess 18 for receiving the coil 12 is formed on the surface 17 of the inductor 10. The recess 18 can prevent the interference between the wound coil 12 and a printed circuit board when the inductor 10 is mounted on the printed circuit board. On the same surface 17, a plurality of contact pads 16 are formed. The coil ends of the coil 12 are connected to the corresponding contact pads 16 such that an external power supply can drive the inductor 10.

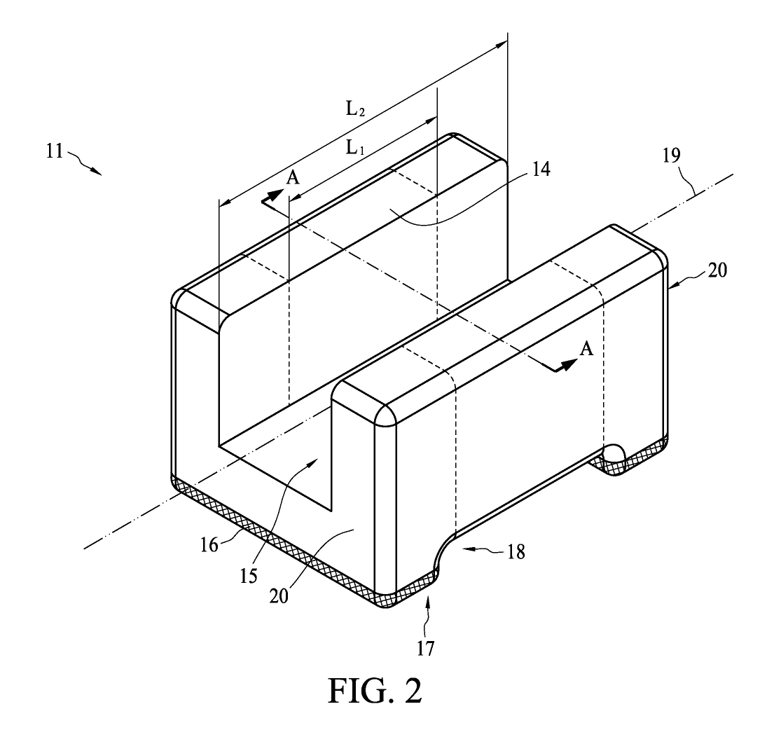

FIG. 2 is a perspective view showing a core member 11 according to one embodiment of the present invention. Referring to FIGS. 1 and 2, the core member 11 comprises a wire-winding portion 14 and a groove portion 15. The wire-winding portion 14 is in the core member 11 where the coil 12 is wound, and the groove portion 15 extends through and beyond the wire-winding portion 14 along the direction of the wire-winding axis 19. In other words, the length L₂ of the groove portion 15 is greater than the length L₁, along the direction of the wire-winding axis 19, of the wire-winding portion 14 so that when the coil 12 is disposed around the core member 11, the entire coil 12 can be wound around the groove portion 15. As a result, the coil 12 can be wound simultaneously around a solid part and around an empty part of the core member 11. In one embodiment of the present invention, the groove portion 15 can be disposed on a surface opposite the surface 17 where the contact pads 16 are disposed. The groove portion 15 can extend between two opposite end surfaces 20 of the core member 11 along the direction of the wire-winding axis 19 as shown in FIG. 2.

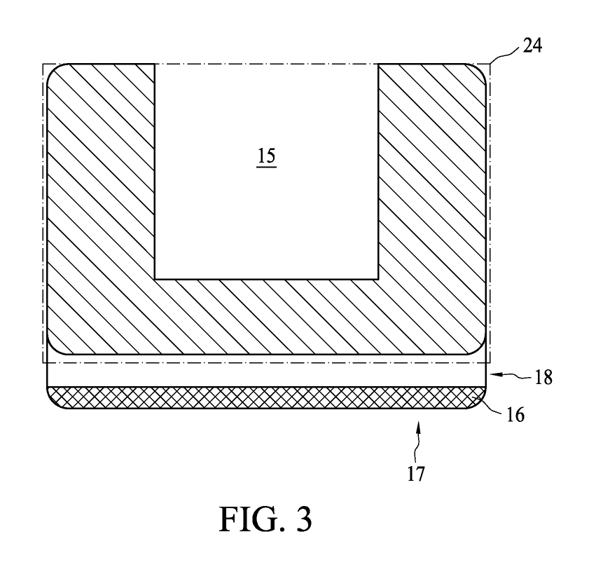

FIG. 3 is a cross-sectional view along line A-A in FIG. 2. Referring to FIGS. 2 and 3, on a cross section 24, within the extent of the length L₁ of the wire-winding portion 14 and perpendicular to the wire-winding axis 19, the cross-sectional area of the groove portion 15 is in the range of from about one-third to one-half of the area of the cross section 24. Consequently, the core member 11 of the present embodiment is a composite core including high magnetic permeability material and low magnetic permeability material. Because the wire-winding portion 14 is made of magnetically permeable material, the magnetic flux lines emanating from the coil 12 can be confined therewithin so as to increase the inductance of the inductor 10. Moreover, the coil 12 is also wound around the groove portion 15 configured as an air core such that the inductor 10 can have high frequency performance as well, like an air-core inductor. Therefore, the inductor 10 including the core member 11 can have high inductance at low frequency and can have low core losses and high Q factor when it is operated at high frequency. In the present embodiment, the permeability of the solid part of the wire-winding portion 14 is in the range of from 60 to 400. The wire-winding portion 14 can include ferrite, nickel zinc ferrite, molybdenum permalloy, magnesium zinc ferrite, and nickel copper zinc ferrite. In the present embodiment, the contour of the cross section 24 of the core member 11 is rectangular, but in other embodiments the contour is not limited thereto. The contour of the cross section 24 can be other shapes such as polygonal, round or elliptical shape. Although the cross-sectional shape of the groove portion 15 in the present embodiment is rectangular, the cross-sectional shape of the groove portion 15 can also be, for example, polygonal, round or elliptical. The shape of the cross section 24 of the core member 11 can be similar to the cross-sectional shape of the groove portion 15 as shown in FIG. 3; however, both can have different shapes. For example, the shape of the cross section 24 of the core member 11 can be rectangular, and the cross-sectional shape of the groove portion 15 can be round.

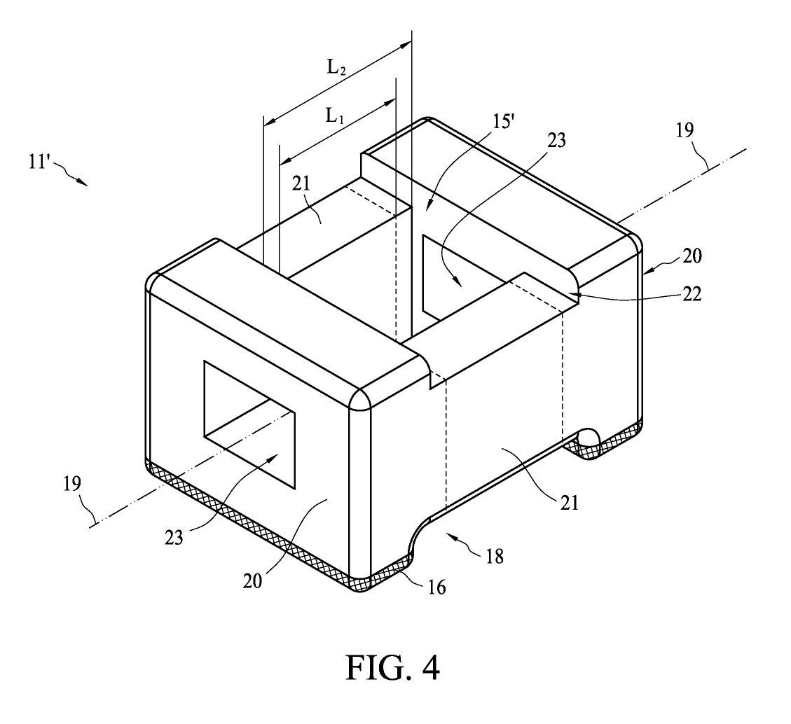

FIG. 4 is a perspective view showing a core member 11′ according to another embodiment of the present invention. Referring to FIGS. 1 and 4, the core member 11′ comprises a wire-winding portion 14 and a groove portion 15′. The wire-winding portion 14 is in the core member 11′ where the coil 12 is wound, and the groove portion 15′ extends through and beyond the wire-winding portion 14 along the direction of the wire-winding axis 19. In other words, the length L₂ of the groove portion 15′ is greater than the length L₁, along the direction of the wire-winding axis 19 of the wire-winding portion 14 so that when the coil 12 is disposed around the core member 11′, the entire coil 12 can be wound around the groove portion 15′. As a result, the coil 12 can be wound simultaneously around a solid part and around an empty part of the core member 11′. Two side walls 21 defining the groove portion 15′ can respectively include indentations 22 disposed at the opening of the groove portion 15′, confining the magnetic flux lines along the wire-winding axis 19 within the core member 11′. The groove portion 15′ can penetrate the two opposite end surfaces 20 of the core member 11′ using two corresponding channels 23.

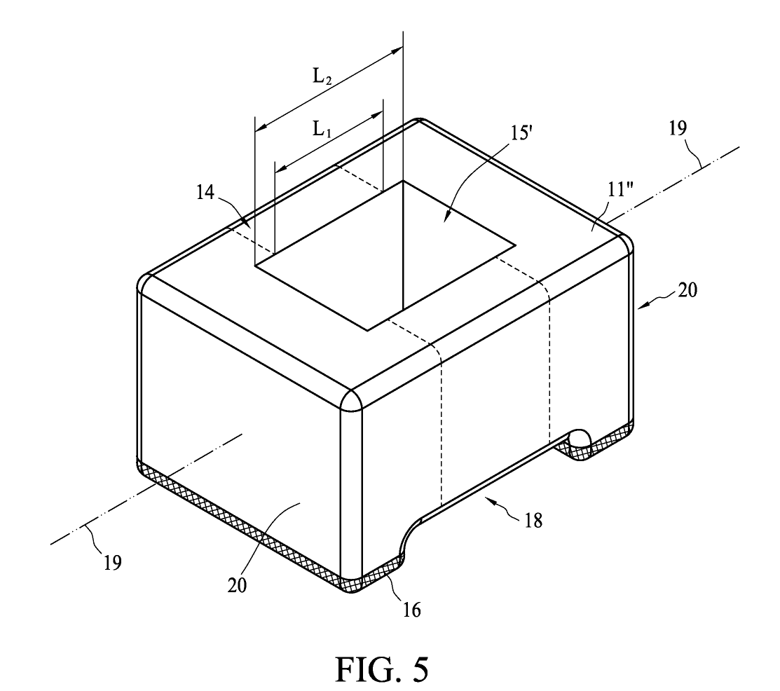

FIG. 5 is a perspective view showing a core member 11″ according to another embodiment of the present invention. Referring to FIGS. 1 and 5, the core member 11″ comprises a wire-winding portion 14 and a groove portion 15′. The wire-winding portion 14 is in the core member 11″ where the coil 12 is wound, and the groove portion 15′ extends through and beyond the wire-winding portion 14 along the direction of the wire-winding axis 19. In other words, the length L₂ of the groove portion 15′ is greater than the length L₁, along the direction of the wire-winding axis 19, of the wire-winding portion 14 so that when the coil 12 is disposed around the core member 11″, the entire coil 12 can be wound around the groove portion 15′. As a result, the coil 12 can be wound simultaneously around a solid part and around an empty part of the core member 11′.

The present invention proposes an inductor having a core member including an air-core portion having a cross-sectional area occupying one-third to one-half of the cross-sectional area of the core member so that the core member can be operated at a broader range of frequencies, and the inductor using the core member can be suitable for more applications.

The above-described embodiments of the present invention are intended to be illustrative only. Numerous alternative embodiments may be devised by persons skilled in the art without departing from the scope of the following claims.

What is claimed is:

1. A core member, comprising:
a groove portion; and
a wire-winding portion, wherein the groove portion extends through the wire-winding portion along a wire-winding axis;
wherein on a cross section perpendicular to the wire-winding axis, a cross-sectional area of the groove portion is in a range of about one-third to one-half of an area of the cross section.

2. The core member of claim 1, wherein the groove portion further extends to two opposite end surfaces of the core member along the direction of the wire-winding axis.

3. The core member of claim 1, further comprising two channels wherein each channel extends from the groove portion to the respective one of two opposite end surfaces of the core member.

4. The core member of claim 1, wherein the permeability of the wire-winding portion is in the range of from 60 to 400.

5. The core member of claim 4, wherein the material of the wire-winding portion includes ferrite, nickel zinc ferrite, molybdenum permalloy, magnesium zinc ferrite, and nickel copper zinc ferrite.

6. The core member of claim 1, further comprising a plurality of contact pads and a recess for receiving a coil, wherein the contact pads are formed on a surface where the recess is disposed.

7. The core member of claim 1, wherein the groove portion's length, along the direction of the wire-winding axis and between the two opposite end surfaces of the core member, is greater than the wire-winding portion's length along the direction of the wire-winding axis.

8. An inductor, comprising:
a core member including a groove portion and a wire-winding portion, the groove portion extending through the wire-winding portion along a wire-winding axis, wherein on a cross section perpendicular to the wire-winding axis, the cross-sectional area of the wire-winding portion is within the range of about one-third to one-half of an area of the cross section of the core member; and
a coil wound around the wire-winding portion.

9. The inductor of claim 8, wherein the groove portion further extends to two opposite end surfaces of the core member along the direction of the wire-winding axis.

10. The inductor of claim 8, further comprising two channels wherein each channel is formed to extend from the groove portion to the respective one of two opposite end surfaces of the core member.

11. The inductor of claim 8, wherein the permeability of the wire-winding portion is in the range of from 60 to 400.

12. The inductor of claim 11, wherein the material of the wire-winding portion includes ferrite, nickel zinc ferrite, molybdenum permalloy, magnesium zinc ferrite, and nickel copper zinc ferrite.

13. The inductor of claim 8, further comprising a plurality of contact pads and a recess for receiving a coil, wherein the contact pads are formed on a surface where the recess is disposed.

14. The inductor of claim 8, wherein the groove portion's length, along the direction of the wire-winding axis and between the two opposite end surfaces of the core member, is greater than the wire-winding portion's length along the direction of the wire-winding axis.
